(19) United States
(12) Patent Application Publication
(10) Pub. No.: US 2026/0166775 A1
(43) Pub. Date: Jun. 18, 2026

(54) System to additively manufacturing constructions or components of constructions

(71) Applicant: PERI SE, Weissenhorn (DE)

(72) Inventors: Chikaeze Ugwu, Weissenhorn (DE); Kevin Li, Weissenhorn (DE); Fabian Meyer-Broetz, Weissenhorn (DE); Sriraam Kanchana, Weissenhorn (DE)

(73) Assignee: PERI SE, Weissenhorn (DE)

(21) Appl. No.: 19/122,336

(22) PCT Filed: Oct. 18, 2023
(86) PCT No.: PCT/EP2023/078970

§ 371 Date: Apr. 18, 2025

(30) Foreign Application Priority Data
Oct. 21, 2022 (DE) 10 2022 127 879.4

(51) Int. Cl. B28C 7/02; B33Y 30/00; B33Y 40/00; B33Y 50/02; E04G 21/04

(52) U.S. Cl. CPC B28C 7/024; B28C 7/026; E04G 21/04; B33Y 30/00; B33Y 40/00; B33Y 50/02; E04G 2021/049

(57) ABSTRACT

The invention relates to a system (1) for additively manufacturing constructions (2) or components of constructions (2), wherein a material discharge unit (3) can be moved in a plurality of degrees of freedom in order to discharge a mixed building material (4) layer-by-layer in predefined print pathways (4a), said system at least comprising:
the material discharge unit (3);
a mixing-and-pumping device (5), which is configured to mix the building material (4) with added water and then convey same from the mixing-and-pumping device (5) to the material discharge unit (3);
at least one first sensor (6), which is suitable for measuring, directly inline, at least two first physical parameters of the mixed building material (4) continuously during the manufacturing process;
a control unit (7) for controlling the manufacturing process, which control unit is communicatively connected at least to the mixing-and-pumping device (5) and the at least one first sensor (6) and which receives at least the measured first physical parameters of the at least one first sensor (6) as input signals and which is furthermore configured to continuously adapt and/or optimize the manufacturing process automatically in real time at least as a function of the first physical parameters of the at least one first sensor (6).

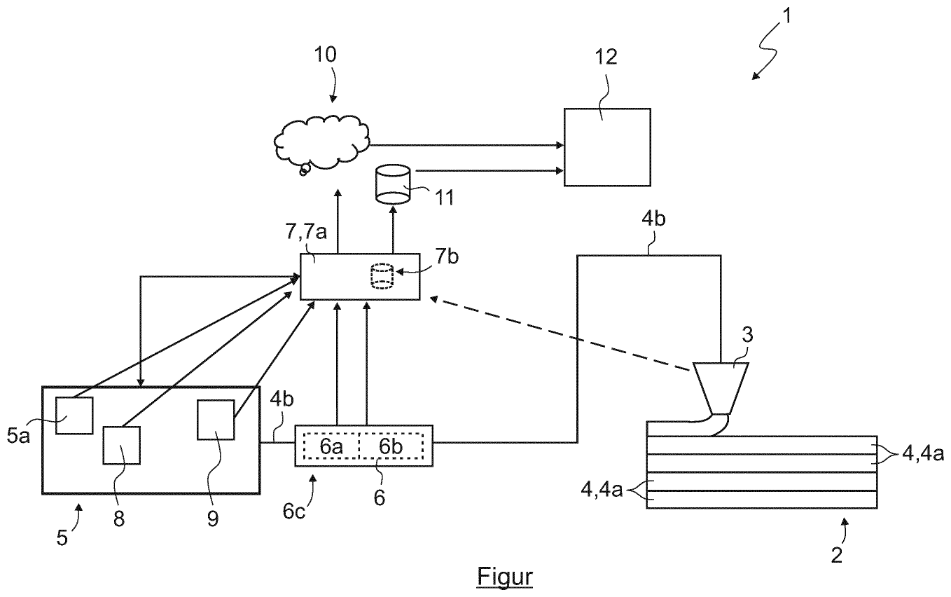

The present application claims the priority of German patent application 10 2022 127 879.4, the content of which is fully incorporated herein by reference thereto.

The invention relates to a system for additively manufacturing constructions or components of constructions.

It is also known to use 3-D printing methods or additive manufacturing methods for manufacturing constructions or components of constructions (for example, walls or formwork). The additive manufacturing of constructions or components thereof can significantly increase productivity in the construction industry. As a result of what is known as “3-D concrete printing,” structures can be produced faster and at lower costs. With the aid of a 3-D concrete printer, concrete structures without formwork can be realized quickly and economically, while at the same time having maximum design freedom.

In such a method or system, a material discharge unit is moved in a plurality of degrees of freedom to discharge a building material (e.g., concrete, mortar, or thermoplastic material) layer-by-layer in predefined print pathways. The print pathways can be calculated based upon 3-D data of the construction or component. Such methods are already known from conventional 3-D printing. The 3-D data of the construction or component can in particular be three-dimensional CAD data. The construction or component can be represented in the data in particular by points, clouds, edge models, surface models, and/or volume models.

In known methods, a wet mortar can be continuously produced as a building material by mixing a dry mortar or dry concrete with water and then pumping or conveying it to a computer-controlled print head or a material discharge unit. A major problem in these processes is the fact that the wet mortar must be fluid enough to be pumped or conveyed, and, when said wet mortar is applied as a layer, it must at the same time have a sufficiently high mechanical resistance to be able to support the next layers above without collapsing.

The control and monitoring of 3-D printing parameters, such as viscosity, water content, and temperature of the mixed building material, is usually done manually or once, and can only be processed and visualized after the completion of a printing session. These conventional methods include, for example, on-site sampling followed by laboratory analysis, and sometimes also require sample preparation prior to testing. Finally, the results report is sent to the site for decision-making. If the print properties determined as a result do not meet the requirements, it may be necessary to rectify the defects, in particular to at least partially destroy the already printed structure, which may lead to further problems such as cracks and inconsistencies in the print. Furthermore, this is a time-consuming and inefficient process, given rapid industrial growth and increasing demand for 3-D-printed houses. Therefore, reliable information on real-time properties of the discharged construction material is desirable for adequate quality control, robustness, and cost reduction through accurate decision-making, improved consistency, and reduced material usage.

In addition, the 3-D concrete printing process is influenced by different printing conditions or environmental conditions and by the change in input parameters of printers and mixing machines, such as transport hose diameter and length, printing speed, layer time, layer thickness, layer width, extrusion. The print rate, cuts, print size, machine type, pump motor power, and material type are also variable parameters for which there is currently no range of values that can be used as a benchmark for quality assurance and control. There are currently no catalogs or specifications that provide standards for measuring the quality of a 3-D printed structure under different conditions.

EP 3 756 845 A1 discloses a system for implementing a production method of structural elements comprising binders and aggregates, in which at least one sensor is provided that is designed to measure at least two physical properties of 3-D-printed wet mortar online on its way from the mixing device to an outlet, wherein the physical properties comprise viscosity and at least one of flowability and density.

Furthermore, reference is made to EP 3 823 801B1 .

Proceeding from this, the present invention is based upon the object of providing a system of the type mentioned at the outset that avoids the disadvantages of the prior art, in particular improves the print quality of additive manufacturing and reduces the usage of materials.

The object is achieved according to the invention by a system having the features mentioned in claim 1.

According to the invention, a system for additively manufacturing constructions or building components is proposed, wherein a material discharge unit can be moved in a plurality of degrees of freedom in order to discharge a mixed building material layer-by-layer in predetermined printing paths, said system at least comprising the material discharge unit; a mixing-and-pumping device, which is configured to mix the building material with added water and then convey same from the mixing-and-pumping device to the material discharge unit; at least one first sensor, which is suitable for measuring, directly inline, at least two first physical parameters of the mixed building material continuously during the manufacturing process or which measures, directly inline, at least two first physical parameters of the mixed building material continuously during the manufacturing process; a control unit for controlling the manufacturing process, which control unit is communicatively connected at least to the mixing-and-pumping device and the at least one first sensor and which receives at least the measured first physical parameters of the at least one first sensor as input signals and which is furthermore configured to continuously adapt and/or optimize the manufacturing process automatically in real time at least as a function of the first physical parameters of the at least one first sensor.

The system according to the invention is provided with an integrated sensor system that is capable of directly ascertaining inline physical properties of the building material used and changing input parameters of the printing process during operation. This further improves the print quality of additive manufacturing and significantly reduces material usage. In a very advantageous manner, the inline measurements in the system according to the invention, which are carried out directly in the manufacturing process, significantly increase the measurement accuracy. In contrast, online measurements are not taken directly in the process, but, rather, for example, in a bypass that is installed for this purpose. Therefore, there is no record of exactly what happens in the process. Other reliable sensors such as viscosity sensors, water content sensors, temperature sensors, pressure sensors, and water flow sensors can be added to measure the properties to achieve adequate quality control, robustness, cost reduction through more accurate decision-making, improved consistency, and reduced material consumption. The invention can further solve the problem of inconsistency during printing by automatically adjusting the water flow rate and water content. This reduces the human effort required to continuously make these adjustments and further maintains the quality of the printed patterns.

Continuous control of the printing process can reduce printing costs, waste, time loss, and inefficiency and increase print quality. In particular, user-friendliness for operators without prior experience in 3-D concrete printing is increased by quantifying print quality, meaning that sensor values can be relied upon to assess material properties without expert skills. By visualizing the sensor values, errors can be detected and assessed more easily. For example, if the water flow rate is too low, but the water content is within an acceptable range, it can be concluded that not enough dry mortar is being pumped from the corresponding container. Thanks to automatic control, significantly less personnel are needed on-site. In addition, safety is increased by the possibility of automatic shutdown of the mixing-and-pumping device if, for example, excessive pressure is detected.

The control unit can, for example, be housed as a sensor box in a separate housing and be provided with a display device for visualization. The control unit can, for example, be designed as a programmable logic controller (PLC). All sensors can be connected to the control unit either directly or via an IO-link master. The displayed data can be connected to a controller for data processing and controlling the printing process. The measuring system (sensors) then carries out measurements on the fresh concrete and sends the data (real performance) to the controller. The control unit or controller then generates usable data from the measured data (e.g., water content, flow, temperature, pressure, and the like), and, if the actual output of the printer corresponds to the expected target output (determined from preset values), no adjustments are made to the input and the printing process, and it continues unchanged. However, if the actual output differs from the expected output, e.g., by a predefined threshold value, or is outside the value range, real-time optimization takes place in the controller, and the printer outputs are adjusted to make the changes. The mixing-and-pumping device can also be designed in two parts, with a mixing device and a pumping device, or can be formed by two different systems.

At least one physical characteristic variable of the manufacturing environment can be determined or measured, in particular, for example, online or inline, preferably continuously during the manufacturing process, by at least one second sensor that can be communicatively connected to the control unit, wherein the control unit receives the at least one physical characteristic variable of the manufacturing environment as an input signal and can furthermore be configured to automatically adapt and/or optimize the manufacturing process continuously in real time as a function of the at least one physical characteristic variable of the manufacturing environment.

This means that one or more physical characteristic variables of the manufacturing environment, such as temperatures or humidities, which are in particular recorded online or inline by one or more second sensors or ascertained by calculation, can also be taken into account in the optimization.

The at least one physical characteristic variable of the manufacturing environment can comprise an ambient temperature, an ambient humidity, or a water flow, in particular upstream of the mixing-and-pumping device.

The at least one physical characteristic variable of the manufacturing environment can further comprise a water temperature in the mixing device or a total amount of water consumed, in particular by the mixing device. Furthermore, a plurality of other parameters/characteristic variables can be recorded, on the basis of which changes can be made to the manufacturing process. These include, for example, hose diameter, hose length, printing speed, layer time, layer thickness and width, print head extrusion rate, print size, mixing pump type, material type, nozzle shape, nozzle system, and pump frequency.

In addition, at least one further physical parameter of the mixed building material can be determined or measured, in particular online or inline, preferably continuously during the manufacturing process, by at least one further sensor that can be communicatively connected to the control unit, wherein the control unit can receive the at least one further physical parameter of the mixed building material as an input signal and can furthermore be configured to automatically adapt and/or optimize the manufacturing process continuously in real time as a function of the at least one further physical parameter of the mixed building material.

These measures also allow other physical parameters or properties of the building material to be taken into account when optimizing the printing process.

The at least one further physical parameter of the mixed building material can be a viscosity. The viscosity of the mixed building material can be determined from an electric current required to drive a mixing-and-pumping device. This can involve an online measurement of process properties.

With an increasing current consumption for driving the mixing spindle of the mixing-and-pumping device, it can also be concluded that the viscosity of the mixed building material is increasing.

The at least one further sensor or one of the sensors in the mixing-and-pumping device can be used to measure the current consumption of the mixing spindle or of the mixing motor or actuator that drives the mixing-and-pumping device. This measured current consumption can be used to determine the viscosity of the building material or the mixed material (preferably consisting of water and dry material). The higher the measured current consumption, the higher the viscosity of the material (with increasing current consumption, the viscosity also increases, i.e., the material becomes more viscous, and vice versa).

As a function of a measured value, characterizing the viscosity, for the current consumption for driving the mixing spindle of the mixing-and-pumping device, the water inflow of the mixing-and-pumping device can be controlled in such a way that the viscosity is kept within a specific value range, wherein preferably an upper and a lower limit value for the viscosity are provided.

Based upon this measured value, the water inflow can be controlled to keep the viscosity within a certain range. An upper limit value and a lower limit value for the viscosity can be provided.

If the upper limit value is exceeded and/or if the lower limit value of the viscosity is not reached, the water inflow to the mixing-and-pumping device can be adjusted accordingly, wherein an increased water inflow reduces the viscosity, and a reduced water inflow increases the viscosity.

If the upper limit is exceeded or the lower limit is not reached, the water inflow rate can be controlled or adjusted accordingly. Increasing the water inflow can reduce the viscosity, while decreasing the water inflow can increase the viscosity. The control unit can process the data and control the valve for the water inflow. Depending upon the dry material, the ratio between water and dry material required for optimal viscosity varies, which is why a database for different materials can exist, which database contains corresponding upper and lower viscosity limit values, depending upon the material. Thus, highly accurate viscosity control can be carried out by measuring the current consumption.

The control unit can be configured to compare the received physical parameters of the mixed building material to predefined value ranges for the physical parameters of the mixed building material, which predefined value ranges are determined on the basis of a database, in particular as a function of the at least one physical characteristic variable and preferably further input variables of the manufacturing process. The control unit can compare the received physical parameters of the building material to predefined values from the database. To ascertain the comparison values to be used from the database, at least one physical characteristic variable and/or other input variables of the manufacturing process are used.

The preset value ranges can serve as a catalog to select appropriate printer and mixing machine variables and environmental conditions, thereby determining the physical parameters or output data that ensure optimal printing performance and structural stability. Many parameters are related to each other and are influenced by different variables. It is possible to determine the effect that a change in a first variable has on another variable. The inventors were thus able to determine value ranges that can be used as presets for printing under different conditions and variables in order to achieve optimal printing performance-for example, in terms of buildability, printability, etc. The parameters of the database can be measured in real time under different printing conditions, various adjustable printer and mixing machine parameters, and with different 3-D-printable materials or building materials in order to obtain perfect value ranges that allow for the highest quality and structurally certified printing. The effects of changes in the variables are determined, and their corresponding impact on the output parameters of the sensors measured in real time is recorded and analyzed. Data obtained over time from numerous tests, with documented analyses, can be presented as preset ranges of expected values that provide the best print quality and structural integrity for specific printer and mixing machine settings and mixing machine conditions.

The database can be designed as a table or database in which the predefined value ranges, which are ascertained in advance, preferably by means of big data learning, are stored as a function of the at least one physical characteristic variable and preferably further input variables of the manufacturing process. In this case, new types of data storage and analysis systems (e.g., parallel processors) can be used to process and analyze potentially large amounts of big data.

The control unit can additionally be connected to a cloud or a data storage unit on which the measurement data received from the first, second, and further sensors are stored.

This allows the real output data from the sensors, which are sent to the operating system of the controller, to be transferred to an offline data memory. The data can also be sent directly to a cloud via a gateway connected to the controller.

The control unit can be configured to adapt and/or optimize the manufacturing process if one or more of the received physical parameters of the mixed building material do not lie within the specific predefined value ranges.

Thus, if the discharged building material differs from the expected target output, real-time optimization can be carried out.

For the purpose of continuously adapting and/or optimizing the manufacturing process, the control unit can be configured to control the mixing-and-pumping device accordingly, and/or to adapt a set layer thickness of the individual print layers or print pathways and/or to set a printing speed of the manufacturing process and/or to set a dosing of the mixed water and/or to set an extrusion rate of the material discharge unit.

These measures allow appropriate changes to be made to the ongoing manufacturing process. The control of the mixing-and-pumping device can comprise an on/off control or a frequency adjustment (e.g., a reduction in the pump speed). For example, the pumping device can automatically shut off if too high a pressure is measured. Furthermore, the layer thickness, i.e., the thickness of an individual print layer or print pathway, can be adjusted if an actually measured layer thickness deviates from a theoretically set, desired layer thickness. If, for example, the measured layer thickness is too low, the print head moves vertically downwards by a specified distance, i.e., it discharges the material at a lower absolute height. Since the building material no longer falls as far, the speed at which the material lands is also reduced, thereby increasing the layer thickness.

The control unit can also be configured to leave the manufacturing process unchanged if the received physical parameters of the mixed building material lie within the specific predefined value ranges.

The control unit can be configured to continuously adapt and/or optimize the manufacturing process automatically in real time by means of a synchronized feedback control.

The controller can use a synchronized feedback control system that continuously adjusts printer inputs to the expected output. This expected output consists of preset or predetermined values derived from prior analysis and print runs to ensure optimized printing with specific printer and mixing machine variables.

The at least two first physical parameters of the mixed building material can comprise a water content, a pressure, in particular in the hose, or a material temperature.

The material temperature, water content, and pressure of the building material in the hose or pipe can be measured, for example, in an outlet of the mixing-and-pumping device. However, measurements can also be taken in other parts of the system, such as at the inlet to the print head, i.e., to the material discharge unit.

The at least one first sensor can thus be designed as a pressure sensor, temperature sensor, or water content sensor.

The at least one first sensor can be arranged in or on a sensor tube, in particular between the mixing-and-pumping device and the material discharge unit, further in particular in the region of a start of a section between the mixing-and-pumping device and the material discharge unit.

The at least one first sensor can be arranged in or on a directly inline sensor tube, in particular on a conveying path or hose path of the mixed building material between the mixing-and-pumping device on the one hand and the material discharge unit on the other, in particular downstream. It is also conceivable to arrange the at least one first sensor on the material discharge unit.

The at least one first sensor can be suitable for continuously measuring, during the manufacturing process, the at least two first physical parameters of the mixed building material directly inline on its path from the mixing-and-pumping device to the material discharge unit, in particular at an outlet of the mixing-and-pumping device or at the beginning of the path of the mixed building material between the mixing-and-pumping device and the material discharge unit.

In principle, the sensor tube or sensor pipe can be attached to both ends of the hose. However, it is particularly advantageous to install it at the end of the mixing-and-pumping device, since the sensor can remain stationary there, and a possible change in the physical parameters becomes immediately visible, without having to wait until the change is visible at the other end of the hose.

The at least one second sensor can be designed as a thermometer, humidity sensor, or flow sensor.

The at least one second sensor can be arranged in the region of the mixing-and-pumping device or on the control unit or on a housing of the control unit.

The at least one further sensor can be designed as an inductive sensor.

The mixed building material can have concrete, mortar, clay, loam, or a thermoplastic material. Of course, additives such as polymers, glass, steel, or mineral fibers can also be added. With regard to the compositions of the building materials that can be used for 3-D concrete printing, reference is also made to EP 3 756 845 A1 and EP 3 823 801 B1 mentioned at the outset.

The control unit and/or the cloud and/or the data storage unit can be accessed via a human-machine interface (HMI) or a web interface. These measures allow the values from the sensors to be visualized offline on an HMI and online on a web interface, which can be programmed to control the mixing process, water flow rate, extrusion rate, and printing speed. The measured data can then be sent to a PC cloud platform, where it can later be processed and stored for future reference. The data can be further used to analyze the integrity of the printed patterns. The sensor values can be displayed on an HMI or a dashboard that can be accessed in any standard web browser.

The material discharge unit can also be communicatively connected to the control unit.

The invention thus comprises a system for additively manufacturing constructions or components of constructions with an integrated sensor system, which can be capable of measuring the viscosity and temperature, the water content, and the pressure of 3-D-printable wet mortar or other building materials, as well as the flow rate, the water temperature, and the total amount of water used by the mixing machine, and the ambient temperature and humidity. These sensor values can be collected by a computer system that is capable of storing, visualizing, and analyzing the sensor data to automate the printing process. In addition, the measurement data can be used to adjust and optimize the manufacturing process in real time.

Advantageous embodiments and developments of the invention are set forth in the dependent claims.

The principle of an exemplary embodiment of the invention is given below, with reference to the drawings.

The sole FIGURE of the drawing shows a highly simplified schematic diagram of the system according to the invention.

The FIGURE shows a system 1 according to the invention for additively manufacturing constructions 2 (indicated only partially and in a highly simplified manner in the FIGURE) or components of constructions 2, wherein a material discharge unit 3 can be moved in a plurality of degrees of freedom in order to discharge a mixed building material 4 layer-by-layer in predefined print pathways 4a. The system 1 comprises at least:
the material discharge unit 3 or the nozzle or print head;
a mixing-and-pumping device 5, which is configured to mix the building material 4 with added water and then convey same from the mixing-and-pumping device 5 to the material discharge unit 3;
at least one first sensor 6, which is suitable for measuring, directly inline, at least two first physical parameters of the mixed building material 4 continuously during the manufacturing process, or which measures, directly inline, at least two first physical parameters of the mixed building material continuously during the manufacturing process;
a control unit 7 for controlling the manufacturing process, which control unit is communicatively connected at least to the mixing-and-pumping device 5 and the at least one first sensor 6 (indicated by arrows in the FIGURE) and which receives at least the measured first physical parameters of the at least one first sensor 6 as an input signal and which is furthermore configured to continuously adapt and/or optimize the manufacturing process automatically in real time at least as a function of the first physical parameters of the at least one first sensor 6.

The at least one first sensor 6 can be designed as a pressure sensor 6a or as a water content sensor 6b. As can be seen from the FIGURE, the at least one first sensor 6, 6a, 6b can be arranged in or on a sensor tube 6c, in particular between the mixing-and-pumping device 5 and the material discharge unit 3, in particular downstream. A conveying path, in particular in a hose or the like, of the mixed building material 4 from the mixing-and-pumping device 5 to the material discharge unit 3 is provided with the reference sign 4b. In further exemplary embodiments, the mixing-and-pumping device 5 can also be divided in two parts separately into a mixing device and a pumping device (not shown).

The mixing-and-pumping device 5 is provided with an actuator 5a, in particular a stepper motor or the like, which moves a valve for the water supply of the mixing-and-pumping device 5. The actuator 5a can adjust the water supply based upon the specifications of the control unit 7.

At least one physical characteristic variable of the manufacturing environment can be determined or measured, in particular, for example, online or inline, preferably continuously during the manufacturing process, by at least one second sensor 8 that is communicatively connected to the control unit 7 (indicated by arrows in the FIGURE), wherein the control unit 7 receives the at least one physical characteristic variable of the manufacturing environment as an input signal and is furthermore configured to additionally automatically adapt and/or optimize the manufacturing process continuously in real time as a function of the at least one physical characteristic variable. The at least one second sensor 8 can be designed as a thermometer, humidity sensor, or flow sensor and can measure an ambient temperature and/or an ambient humidity and/or a water flow, in particular upstream of the mixing-and-pumping device 5, as a physical characteristic variable of the manufacturing environment. The at least one second sensor 8 can, as in the present exemplary embodiment, be arranged in the region of, or in front of or in, the mixing-and-pumping device 5, or, in further exemplary embodiments not shown, it can be arranged on the control unit 7 or on a housing 7a of the control unit 7 or in further regions of the manufacturing environment.

In further exemplary embodiments, the material discharge unit 3 can also be communicatively connected to the control unit 7 (indicated by a dashed arrow).

At least one further physical parameter of the mixed building material 4 can be determined or measured, in particular online or inline, preferably continuously during the manufacturing process, by at least one further sensor 9 that is communicatively connected to the control unit 7 (indicated by arrows in the FIGURE), wherein the control unit 7 receives the at least one further physical parameter of the mixed building material 4 as an input signal and is furthermore configured to additionally automatically adapt and/or optimize the manufacturing process continuously in real time as a function of the at least one further physical parameter of the mixed building material 4.

The at least one further sensor 9 can be designed as an inductive sensor and thus allow the viscosity of the mixed building material 4 to be determined as a further physical parameter from an electric current required to drive a mixing spindle (not shown) of the mixing-and-pumping device 5.

With an increasing current consumption for driving the mixing spindle of the mixing-and-pumping device 5, it can also be concluded that the viscosity of the mixed building material is increasing. The at least one further sensor 9 or one of the sensors in the mixing-and-pumping device 5 can be used to measure the current consumption of the mixing spindle or of the mixing motor or actuator that drives the mixing-and-pumping device 5. This measured current consumption can be used to determine the viscosity of the building material 4 or the mixed material (preferably consisting of water and dry material). The higher the measured current consumption, the higher the viscosity of the material (with increasing current consumption, the viscosity also increases, i.e., the material becomes more viscous, and vice versa). As a function of this measured value, the water inflow can be controlled via the actuator 5a to keep the viscosity within a certain range. An upper limit value and a lower limit value for the viscosity can be provided. If the upper limit value is exceeded and the lower limit value is not reached, the actuator 5a can be activated and control or adjust the water inflow rate accordingly. Increasing the water inflow can reduce the viscosity, while decreasing the water inflow can increase the viscosity. The control unit 7 can process the data and control the valve for the water inflow. Depending upon the dry material, the ratio between water and dry material required for optimal viscosity varies, which is why a database for different materials can exist, which database contains corresponding upper and lower viscosity limit values, depending upon the material. Thus, highly accurate viscosity control can be carried out by measuring the current consumption.

The at least one physical characteristic variable of the manufacturing environment can also comprise a water temperature in the mixing-and-pumping device 5 or a total amount of water consumed, in particular by the mixing-and-pumping device 5.

The control unit 7 can be configured to compare the received physical parameters of the mixed building material 4 to predefined value ranges through the physical parameters of the mixed building material 4, which predefined value ranges are determined on the basis of a database 7b, in particular as a function of the at least one physical characteristic variable and preferably further input variables of the manufacturing process.

The database 7b can be communicatively connected to the control unit 7 or can be present in a memory element (not shown in detail) of the control unit 7.

The control unit 7 can further be configured to adapt and/or optimize the manufacturing process if one or more of the received physical parameters of the mixed building material 4 do not lie within the specific predefined value ranges. The use of threshold values or the like can also be considered.

For the purpose of continuously adapting and/or optimizing the manufacturing process, the control unit 7 can be configured to:
control the mixing-and-pumping device 5 accordingly and/or
adapt a set layer thickness or layer thickness of the individual print pathways 4a and/or
set a printing speed of the manufacturing process and/or
set a dosing of the mixed water and/or
set an extrusion rate of the material discharge unit 3.

The control unit 7 can be configured to leave the manufacturing process unchanged if the received physical parameters of the mixed building material 4 lie within the specific predefined value range.

The control unit 7 can be configured to continuously adapt and/or optimize the manufacturing process automatically in real time by means of a synchronized feedback control.

The at least two first physical parameters of the mixed building material 4 can comprise a water content, a pressure, and/or a material temperature.

The mixed building material 4 can have concrete, mortar, clay, loam, or a thermoplastic material.

The database 7b can be designed as a table or database in which the predefined value ranges, which are ascertained in advance, preferably by means of big data learning, are stored as a function of the at least one physical characteristic variable and preferably further input variables of the manufacturing process.

As can be further seen from the FIGURE, the control unit 7 can additionally be connected to a cloud 10 or a data storage unit 11 on which the measurement data obtained from the first, second, and further sensors 6, 6a, 6b, 8, 9 are stored.

The control unit 7 and/or the cloud 10 and/or the data storage unit 11 can be accessed via a human-machine interface (HMI) or a web interface.

A simplified display unit of the system 1 is provided with the reference sign 12.

### LIST OF REFERENCE SIGNS

1 system
2 construction
3 material discharge unit (nozzle)
4 mixed building material
4a print pathway
4b conveying path of the mixed building material
5 mixing-and-pumping device
5a actuator
6 first sensor
6a pressure sensor
6b water content sensor
6c sensor tube
7 control unit
7a housing of the control unit 7
7b database
8 second sensor
9 further sensor (inductive sensor)
10 cloud
11 data storage unit
12 display unit

1. A system (1) for additively manufacturing constructions (2) or components of constructions (2), wherein a material discharge unit (3) can be moved in a plurality of degrees of freedom in order to discharge a mixed building material (4) layer-by-layer in predefined print pathways (4a), said system at least comprising:
the material discharge unit (3);
a mixing-and-pumping device (5), which is configured to mix the building material (4) with added water and then convey same from the mixing-and-pumping device (5) to the material discharge unit (3);
at least one first sensor (6, 6a, 6b), which is suitable for measuring, directly inline, at least two first physical parameters of the mixed building material (4) continuously during the manufacturing process;
a control unit (7) for controlling the manufacturing process, which control unit is communicatively connected at least to the mixing-and-pumping device (5) and the at least one first sensor (6, 6a, 6b) and which receives at least the measured first physical parameters of the at least one first sensor (6, 6a, 6b) as input signals and which is furthermore configured to continuously adapt and/or optimize the manufacturing process automatically in real time at least as a function of the first physical parameters of the at least one first sensor (6, 6a, 6b).

2. The system (1) according to claim 1,
characterized in that
at least one physical characteristic variable of the manufacturing environment is determined or measured, preferably continuously during the manufacturing process, by at least one second sensor (8) that is communicatively connected to the control unit (7), wherein the control unit (7) receives the at least one physical characteristic variable of the manufacturing environment as an input signal and is furthermore configured to additionally automatically adapt and/or optimize the manufacturing process continuously in real time as a function of the at least one physical characteristic variable of the manufacturing environment.

3. The system (1) according to claim 1 or 2,
characterized in that
at least one further physical parameter of the mixed building material (4) is determined or measured, in particular online or inline, preferably continuously during the manufacturing process, by at least one further sensor (9) that is communicatively connected to the control unit (7), wherein the control unit (7) receives the at least one further physical parameter of the mixed building material (4) as an input signal and is furthermore configured to additionally automatically adapt and/or optimize the manufacturing process in real time as a function of the at least one further physical parameter of the mixed building material (4).

4. The system (1) according to claim 1, 2, or 3,
characterized in that
the control unit (7) is configured to compare the received physical parameters of the mixed building material (4) to predefined value ranges for the physical parameters of the mixed building material (4), which predefined value ranges are determined on the basis of a database (7b), in particular as a function of the at least one physical characteristic variable and preferably further input variables of the manufacturing process.

5. The system (1) according to claim 4,
characterized in that
the control unit (7) is configured to adapt and/or optimize the manufacturing process if one or more of the received physical parameters of the mixed building material (4) do not lie within the specific predefined value ranges.

6. The system (1) according to any of claims 1 to 5, wherein, for the purpose of continuously adapting and/or optimizing the manufacturing process, the control unit (7) is configured to:
control the mixing-and-pumping device (5) accordingly and/or
adapt a set layer thickness of the individual print pathways (4a) and/or
set a printing speed of the manufacturing process and/or
set a dosing of the mixed water and/or
set an extrusion rate of the material discharge unit (3).

7. The system ( ) according to claim 4, 5, or 6,
characterized in that
the control unit (7) is configured to leave the manufacturing process unchanged if the received physical parameters of the mixed building material (4) lie within the specific predefined value ranges.

8. The system (1) according to any of claims 1 to 7,
characterized in that
the control unit (7) is configured to continuously adapt and/or optimize the manufacturing process automatically in real time by means of a synchronized feedback control.

9. The system (1) according to any of claims 1 to 8,
characterized in that
the at least two first physical parameters of the mixed building material (4) comprise a water content, a pressure, and/or a material temperature.

10. The system (1) according to any of claims 2 to 9,
characterized in that
the at least one physical characteristic variable of the manufacturing environment comprises an ambient temperature, an ambient humidity, a water flow, in particular upstream of the mixing-and-pumping device (5), a water temperature, in particular in or upstream of the mixing-and-pumping device (5), or a total amount of water consumed, in particular by the mixing-and-pumping device (5).

11. The system (1) according to any of claims 3 to 9,
characterized in that
the at least one further physical parameter of the mixed building material (4) is a viscosity.

12. The system (1) according to claim 11,
characterized in that
the viscosity of the mixed building material is determined from an electric current required to drive a mixing spindle of the mixing-and-pumping device (5).

13. The system (1) according to any of claims 1 to 12,
characterized in that
the at least one first sensor (6, 6a, 6b) is suitable for continuously measuring, during the manufacturing process, the at least two first physical parameters of the mixed building material (4) directly inline on its path from the mixing-and-pumping device (5) to the material discharge unit (3), in particular at an outlet of the mixing-and-pumping device (5) or at the beginning of the path of the mixed building material (4) between the mixing-and-pumping device (5) and the material discharge unit (3).

14. The system (1) according to any of claims 1 to 13,
characterized in that
the control unit (7) is additionally connected to a cloud (10) or a data storage unit (11) on which the measurement data obtained from the first, second, and further sensors (6, 6a, 6b, 8, 9) are stored.

15. The system (1) according to any of claims 4 to 14,
characterized in that
the database (7b) is designed as a table or database in which the predefined value ranges, which are ascertained in advance, preferably by means of big data learning, are stored as a function of the at least one physical characteristic variable and preferably further input variables of the manufacturing process.

16. The system (1) according to any of claims 1 to 15,
characterized in that
the at least one first sensor (6) is designed as a pressure sensor (6a), temperature sensor, or water content sensor (6b).

17. The system (1) according to any of claims 1 to 16,
characterized in that
the at least one first sensor (6, 6a, 6b) is arranged in or on a sensor tube (6c), in particular between the mixing-and-pumping device (5) and the material discharge unit (3), further in particular in the region of a start of a section between the mixing-and-pumping device (5) and the material discharge unit (3).

18. The system (1) according to any of claims 2 to 17,
characterized in that
the at least one second sensor (8) is designed as a thermometer, humidity sensor, or flow sensor.

19. The system (1) according to any of claims 2 to 18,
characterized in that
the at least one second sensor (8) is arranged in the region of the mixing-and-pumping device (5) or on the control unit (7) or on a housing (7a) of the control unit (7).

20. The system (1) according to any of claims 3 to 19,
characterized in that
the at least one further sensor (9) is designed as an inductive sensor.

21. The system (1) according to any of claims 1 to 20,
characterized in that
the mixed building material (4) has concrete, mortar, clay, loam, or a thermoplastic material.

22. The system (1) according to any of claims 1 to 21,
characterized in that
the control unit (7) and/or the cloud (10) and/or the data storage unit (11) can be accessed via a human-machine interface, HMI, or a web interface.

23. The system (1) according to any of claims 1 to 22,
characterized in that
the material discharge unit (3) is communicatively connected to the control unit (7).

24. The system (1) according to any of claims 12 to 23,
characterized in that,
with increasing current consumption for driving the mixing spindle of the mixing-and-pumping device (5), it is also concluded that the viscosity of the mixed building material is increasing.

25. The system (1) according to any of claims 12 to 24,
characterized in that,
as a function of a measured value, characterizing the viscosity, for the current consumption for driving the mixing spindle of the mixing-and-pumping device (5), the water inflow of the mixing-and-pumping device (5) is controlled in such a way that the viscosity is kept within a specific value range, wherein preferably an upper and a lower limit value for the viscosity are provided.

26. The system (1) according to claim 25,
characterized in that,
if the upper limit value is exceeded and/or if the lower limit value of the viscosity is not reached, the water inflow to the mixing-and-pumping device (5) is adjusted accordingly, wherein an increased water inflow reduces the viscosity, and a reduced water inflow increases the viscosity.
